(19) United States
(12) Patent Application Publication
(10) Pub. No.: US 2015/0268390 A1
(43) Pub. Date: Sep. 24, 2015

(54) OPTICAL FILM HAVING MICROSTRUCTURE LAYER ON BOTH SIDES

(71) Applicant: NATIONAL TAIWAN NORMAL UNIVERSITY, Taipei City (TW)

(72) Inventors: Tun-Chien TENG, Taipei City (TW); Wei-Che LAI, Taipei City (TW)

(73) Assignee: NATIONAL TAIWAN NORMAL UNIVERSITY, Taipei City (TW)

(21) Appl. No.: 14/277,171

(22) Filed: May 14, 2014

(30) Foreign Application Priority Data
Mar. 21, 2014 (TW) 103110657

(51) Int. Cl. G02B 5/04

(52) U.S. Cl. CPC G02B 5/045

(57) ABSTRACT

An optical film having a microstructure layer on both sides comprises a transparent substrate, a first microstructure layer, and a second microstructure layer. The transparent substrate has a first optical surface and a second optical surface opposite the first optical surface. The first microstructure layer is located on the first optical surface, and comprises a plurality of cylindrical structures. Each of the cylindrical structures has a curved surface. The second microstructure layer is located on the second optical surface, and comprises a plurality of prism structures. Each of the prism structures has a first surface to perpendicular to the transparent substrate and a second surface having a reflection center, which aligns with one of the corresponding cylindrical structures.

### CROSS-REFERENCE TO RELATED APPLICATIONS

This application claims priority to Taiwan Application Serial Number 103110657, filed on Mar. 21, 2014, which is herein incorporated by reference.

### FIELD OF THE INVENTION

The present invention relates to an optical film, and more particularly to an optical film having a microstructure layer on both sides.

### BACKGROUND OF THE INVENTION

Optical films are one of the important constitutional members in optoelectric products. In general, optical films with a single layer or multiple layers are applied to a particular optical element for exhibiting special optical properties. Optical films are used widely in various optoelectric products, such as optical instruments, liquid crystal devices, and solar cell products.

Recently, liquid crystal devices have been used in modern electronic products, such as personal computers, digital cameras, smart phones, tablet computers, liquid crystal televisions, and so on. Liquid crystal devices have several merits: low power requirements, higher brightness, and exceptional color saturation. It is worth noting that the backlight module is one of the key components of the liquid crystal devices because it will influence the power consumption, brightness, and color saturation of the liquid crystal devices.

In general, in order to achieve better display effects for liquid crystal devices, the light guide plate of the backlight modules will be combined with a particular optical film. The optical film is used for directing light beams emitted by a light source towards a desired work surface. To achieve the above object, a microstructure array must be deployed on the surface of the optical film. It is understood that the light extraction efficiency of the backlight modules is improved by particular exterior designs and the arrangement of the microstructure array. Therefore, the design and arrangement of the microstructure array is an important technical feature of the display devices.

Please refer to FIG. 1, FIG. 2, and FIG. 3. FIG. 1 illustrates an optical film having a microstructure layer on both sides of the prior art. FIG. 2 and FIG. 3 illustrate schematic cross-sectional views of an optical film along directions perpendicular to each other according to the prior art. In the prior art, an optical film 10 comprises a transparent substrate 11, a first microstructure layer 12, is and a second microstructure layer 13. The first microstructure layer 12 is located on a first optical surface 11 a of the transparent substrate 11, and the second microstructure layer 13 is located on a second optical surface 11b opposite the first optical surface 11a of the transparent substrate 11. The first microstructure layer 12 comprises a plurality of cylindrical structures, and each of the cylindrical structures has a spherical surface. The second microstructure layer 13 comprises a plurality of prism structures, and each of the prism structures has a first surface 13a and a second surface 13b opposite the first surface 13a. In general, an angle between the first surface 13a and the second optical surface 11b of the transparent substrate 11 is an acute angle.

When the first surface 13a of the second microstructure layer 13 is a light incident surface and the spherical surface of the first microstructure layer 12 is a light exit surface, light beams (i.e. light beam I) enter the first surface 13a of the second microstructure layer 13 and travel inside the second microstructure layer 13 until they reach a reflection center 13r on the second surface 13b of the second microstructure layer 13, and then the light beams are reflected by the reflection center 13r, and directed along a direction toward the first microstructure layer 12. However, due to the first surface 13a of the second microstructure layer 13 being an inclined plane, the angle of incidence will have a wide range. Light beams (i.e. light beam I′ and light beam I″) directed toward the transparent substrate 11 are divergent. That is, the light beams directed from the second microstructure layer 13 is cannot be effectively concentrated on an optical center of the first microstructure layer 12. Therefore, when the optical film 10 is applied to the backlight module of the display devices, partial light beams cannot be effectively concentrated on the optical center of the first microstructure layer 12 after being reflected by the second microstructure layer 13, so that the light extraction efficiency of the backlight module is reduced.

Further, please refer to FIG. 3. In the prior art, the first microstructure layer 12 comprises a plurality of cylindrical structures, and each of the cylindrical structures has a spherical surface. However, because of spherical aberration, only the light beams near an optical axis O of the first microstructure layer 12 will exit the spherical surface approximately collimated as expected. The partial light beams (i.e. light beam I′) far away from the optical axis O passing through the spherical surface will converge. That is, the light beams far away from the optical axis O cannot exit the first microstructure layer 12 approximately collimated (in a direction approximately parallel with the optical axis O). In addition, another partial light beams (i.e. light beam I″) far away from the optical axis O will be reflected by the spherical surface, and directed in a directed toward the second microstructure layer 13. Therefore, when the optical film 10 is applied to the backlight module of the display devices, the two problems given above will cause the light extraction efficiency of the backlight modules to be reduced.

### SUMMARY OF THE INVENTION

A primary object of the present invention is to provide an optical film having a microstructure layer on both sides. The optical film comprises a first microstructure layer located on a first optical surface of a transparent substrate, and a second microstructure layer located on a second optical surface opposite the first optical surface of the transparent substrate. The second microstructure layer comprises a first surface and a second surface opposite the first surface. In the present invention, the first surface is perpendicular to the transparent substrate. When the first surface of the second microstructure layer is a light incident surface, the light beams enter the first surface, and they will be concentrated on an optical center of the first microstructure layer after reflecting by the second surface.

Another object of the present invention is to provide an optical film having a microstructure layer on both sides. The optical film comprises a first microstructure layer located on a first optical surface of a transparent substrate, and a second microstructure layer located on a second optical surface opposite the first optical surface of the transparent substrate. The first microstructure layer has a plurality of curved surfaces, and each of the curved surfaces is an aspherical surface. When the curved surface of the first microstructure layer is a light incident surface, the light beams will exit the curved surface approximately collimated.

To achieve the above object, the present invention provides an optical film having a microstructure layer on both sides. The optical film comprises a is transparent substrate having a first optical surface and a second optical surface opposite the first optical surface; a first microstructure layer located on the first optical surface, and comprising a plurality of cylindrical structures, and each of the cylindrical structures having a curved surface; a second microstructure layer located on the second optical surface, and comprising a plurality of prism structures, and each of the prism structures having a first surface perpendicular to the transparent substrate and a second surface having a reflection center, which aligns with one of the corresponding cylindrical structures.

According to an aspect of the present invention, the second surface of each of the prism structures comprises multiple slopes.

According to another aspect of the present invention, each of the prism structures further comprises a third surface and a fourth surface opposite the third surface. The third surface is connected with the first surface and the second surface, and the fourth surface is also connected with the first surface and the second surface. The third surface and the fourth surface are mutually symmetrical.

According to another aspect of the present invention, the curved surface of each of the cylindrical structures is an aspherical surface or an ellipsoidal surface.

### BRIEF DESCRIPTION OF THE DRAWINGS

FIG. 1 illustrates an optical film having a microstructure layer on is both sides of the prior art.

FIG. 2 and FIG. 3 illustrate schematic cross-sectional views of an optical film along directions perpendicular to each other according to the prior art.

FIG. 4 and FIG. 5 illustrate schematic cross-sectional views of an optical film along directions perpendicular to each other according to one embodiment of the present invention.

FIG. 6 illustrates prism structures of an optical film according to one embodiment of the present invention.

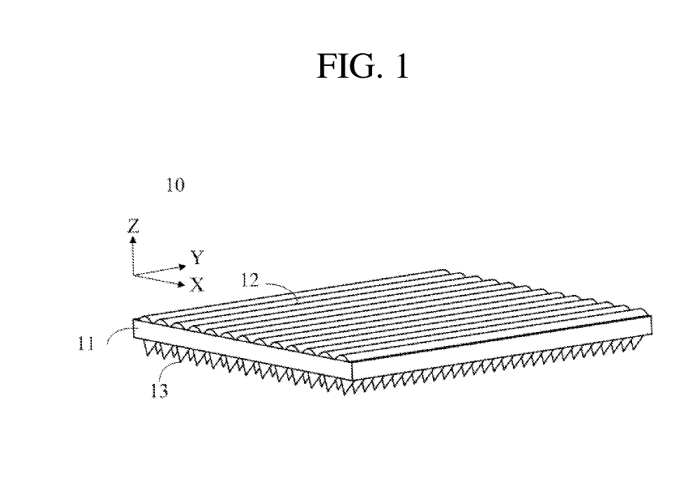

### DETAILED DESCRIPTION OF THE INVENTION

The structure and the technical means adopted by the present invention to achieve the above and other objects can be best understood by referring to the following detailed description of the preferred embodiments and the accompanying drawings. Furthermore, directional terms described by the present invention, such as upper, lower, front, back, left, right, inner, outer, side, longitudinal/vertical, transverse/horizontal, etc., are only directions by referring to the accompanying drawings, and thus the used directional terms are used to describe and understand the present invention, but the present invention is not limited thereto. In addition, the same reference numerals refer to the same parts or like parts throughout the various figures.

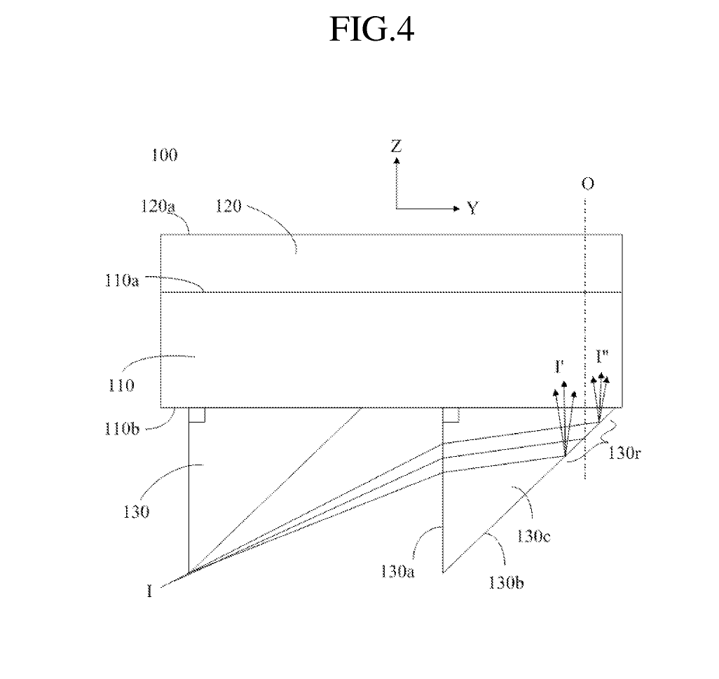

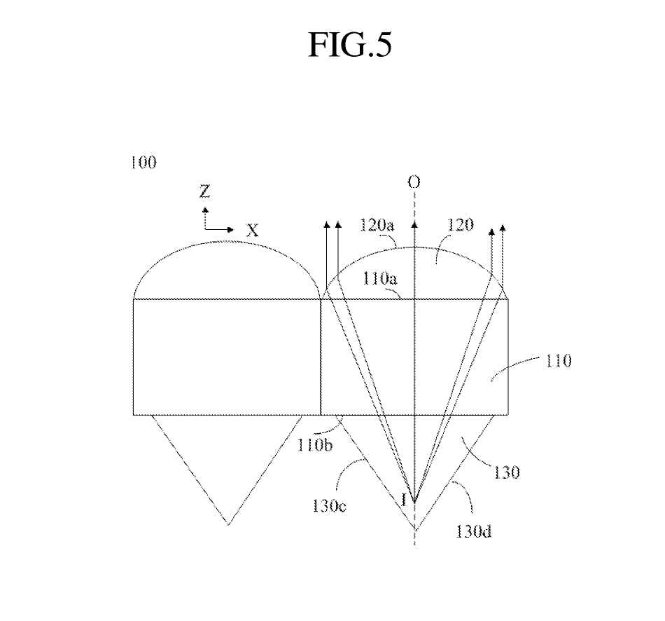

Please refer to FIG. 4 and FIG. 5. FIG. 4 and FIG. 5 illustrate schematic cross-sectional views of an optical film along directions perpendicular to each other according to one embodiment of the present invention. An optical film 100 of the present invention comprises a transparent substrate 110, a first microstructure layer 120, and a second microstructure layer 130. The first microstructure layer 120 is located on a first optical surface 110a of the transparent substrate 110, and the second microstructure layer 130 is located on a second optical surface 110b opposite the first optical surface 110a of the transparent substrate 110.

The first microstructure layer 120 comprises a plurality of cylindrical structures, and each of the cylindrical structures has a curved surface 120a. The second microstructure layer 130 comprises a plurality of prism structures, and each of the prism structures has at least four surfaces; for example, a first surface 130a, a second surface 130b opposite the first surface 130a, a third surface 130c, and a fourth surface 130d opposite the third surface 130c. The plurality of prism structures corresponds to one of the cylindrical structures.

Furthermore, the outlines of the first surface 130a and the second surface 130b of each of the prism structures are preferred isosceles geometrical shapes, such as isosceles triangles or isosceles trapezoids. When the outlines of the first surface 130a, the second surface 130b, the third surface 130c, and the fourth surface 130d are isosceles triangles, the shape of each of the prism is structures is a square pyramid.

On the other hand, the manufacturing method of the optical film 100 of the present invention comprises injection molding, laser engraving, etching, and printing. The first microstructure layer 120 and the second microstructure layer 130 are formed on the transparent substrate 110 by the printing method comprises the steps: coating a layer of Ultraviolet (UV) light curing adhesives on the first optical surface 110a of the transparent substrate 110; contacting a first imprint mold with the layer of UV light curing adhesives; exposing the layer of UV light curing adhesives by UV light for forming the first microstructure layer 120 having a plurality of cylindrical structures on the first optical surface 110a of the transparent substrate 110; coating a layer of UV light curing adhesives on the second optical surface 110b of the transparent substrate 110; contacting a second imprint mold with the layer of UV light curing adhesives; and exposing the layer of UV light curing adhesives by UV light for forming the second microstructure layer 130 having a plurality of prism structures on the second optical surface 110b of the transparent substrate 110. In the step of forming the second microstructure layer 130, UV light is emitted from the surface of the first microstructure layer 120 for curing the UV light curing adhesives to form a plurality of prism structures according to the cylindrical structures' focusing properties and the restriction of the second imprint mold.

In the preferred embodiment of the present invention, the first surface 130a of the second microstructure layer 130 is generally embodied as a light incident surface, and the curved surface 120a of the first microstructure layer 120 is generally embodied as a light exit surface. Therefore, light beams (i.e. light beam I) enter the first surface 130a of the second microstructure layer 130 and travel inside the second microstructure layer 130 until they reach a reflection center 130r on the second surface 130b of the second microstructure layer 130, and then the light beams are reflected by the reflection center 130r and directed along a direction toward the first microstructure layer 120. Finally, the light beams exit the curved surface 120a of the first microstructure layer 120 along a direction away from the optical film 100.

As shown in FIG. 4, the first surface 130a of the second microstructure layer 130 is perpendicular to the transparent substrate 110. When the light beams (i.e. light beam I) enter the first surface 130a, the distribution of incident angles of the light beams concentrates in a certain range, so that the range of the reflection center 130r on the second surface 130b will be concentrated. Therefore, the range of the light beams (i.e. light beam I′ and light beam I″) toward the transparent substrate 110 will be concentrated.

It should be noted that the reflection center 130r of the optical film 100 of the present invention aligns with one of the corresponding cylindrical structures. To be specific, the reflection center 130r of one of the prism structures is located on an optical axis O of the corresponding curved surface 120a. That is, the is light beams (i.e. light beam I′) from the second microstructure layer 130 will be effectively concentrated on an optical center of the first microstructure layer 120. Therefore, when the optical film 100 of the present invention is applied to the backlight module of display devices, the light extraction efficiency of the backlight modules is improved since the light beams reflected by the reflection center 130r of the second microstructure layer 130 can be efficiency concentrated on an optical center of the first microstructure layer 120.

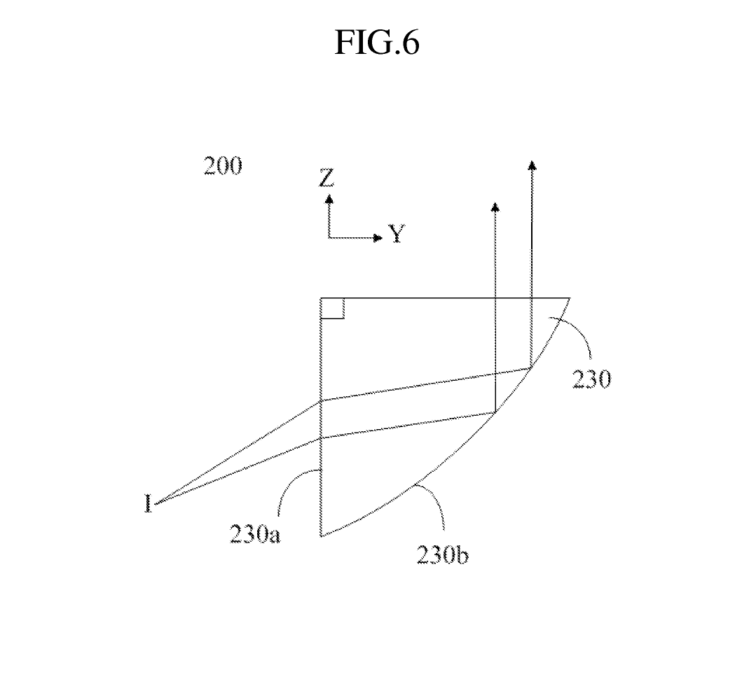

According to another embodiment of the present invention, a second surface 230b of a second microstructure layer 230 of an optical film 200 comprises multiple slopes, as shown in FIG. 6. Since the second surface 230b comprises multiple slopes, the light beams entering from first surface 230a with different incident angles will be collimated and directed along a direction toward a first microstructure layer (not shown) after reflecting by the second surface 230b. That is, when the second surface 230b is embodied with multiple slopes, the light beams reflected by the second surface 230b will be effectively collimated.

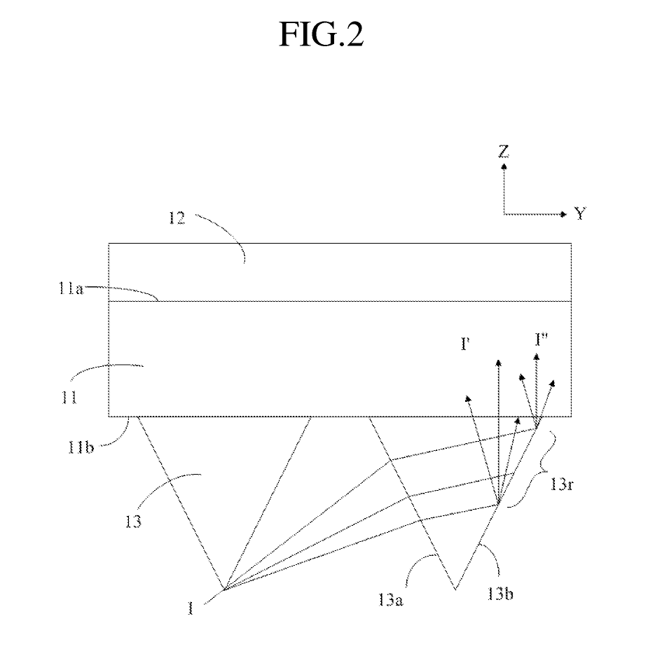

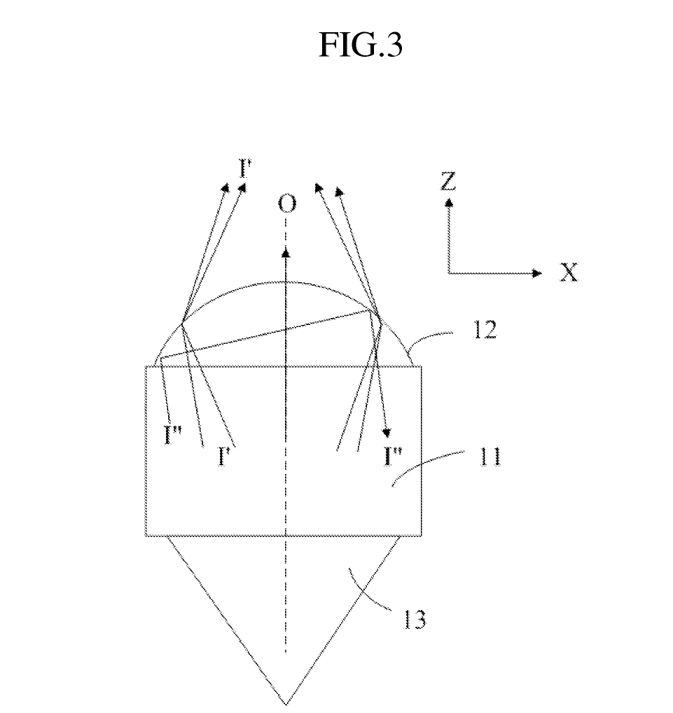

The other objective of the present invention is to prevent spherical aberration caused by the spherical surface of the cylindrical structures in the prior art (as shown in FIG. 2). Because of spherical aberration, partial light beams (i.e. light beam I′) far away from the optical axis O passing through the spherical surface will converge, and another partial light beams (i.e. light beam I″) far away from the optical axis O will be reflected by the spherical surface, and then directed in a is direction toward the second microstructure layer 13. Therefore, when the optical film 10 with the spherical surface of the prior art is applied to the backlight module of display devices, it will cause the light extraction efficiency of the backlight modules to be reduced.

In order to solve the above problem, according to a preferred embodiment of the present invention, the first microstructure layer 120 comprises a plurality of cylindrical structures, and the curved surface 120a of each of the cylindrical structures is an aspherical surface. In another preferred embodiment, the curved surface 120a of each of the cylindrical structures is an ellipsoidal surface. After the light beams (i.e. light beam I) are reflected by the reflection center 130r of the second microstructure layer 130, they are directed along a direction toward the first microstructure layer 120, and passed through the curved surface 120a. Since the surface of the first microstructure layer 120 is an aspherical surface, not only the light beams near an optical axis O of the first microstructure layer 120 will exit the aspherical surface approximately collimated (in a direction approximately parallel with the optical axis O), but also a partial light beams far away from the optical axis O will exit the aspherical surface approximately collimated. That is, the light beams far away from the optical axis O can exit the curved surface 120a in a direction approximately parallel with the optical axis O. Therefore, when the optical film 100 of the present invention is applied to backlight modules of display devices, the light beams will effectively pass through a polarizer of the display devices since is the light beams exit the aspherical surface approximately collimated. Further, the light extraction efficiency of the backlight modules is improved.

According to another preferred embodiment of the present invention, the curved surface 120a of each of the cylindrical structures is an ellipsoidal surface. To be specific, in one exemplary embodiment, the curvature of the ellipsoidal surface is 27.1 mm⁻¹, and the aspherical coefficient is −0.442. In another exemplary embodiment, the curvature of the ellipsoidal surface is 0.0245 mm⁻¹, and the aspherical coefficient is −0.445. According to the above exemplary embodiments, the light beams will exit the curved surface 120a of the first microstructure layer 120 approximately collimated (in a direction approximately parallel with the optical axis O).

The present invention has been described with preferred embodiments thereof and it is understood that many changes and modifications to the described embodiments can be carried out without departing from the scope and the spirit of the invention that is intended to be limited only by the appended claims.

What is claimed is:

1. An optical film having a microstructure layer on both sides, comprising:
a transparent substrate having a first optical surface and a second optical surface opposite the first optical surface;
a first microstructure layer located on the first optical surface, and comprising a plurality of cylindrical structures, each of the cylindrical structures having a curved surface;
a second microstructure layer located on the second optical surface, and comprising a plurality of prism structures, each of the prism structures having a to first surface perpendicular to the transparent substrate and a second surface having a reflection center,
wherein the reflection center aligns with one of the corresponding cylindrical structures.

2. The optical film as claimed in claim 1, wherein the reflection center of is each of the prism structures is located on an optical axis of the curved surface of one of the cylindrical structures.

3. The optical film as claimed in claim 1, wherein the second surface of each of the prism structures comprises multiple slopes.

4. The optical film as claimed in claim 1, wherein outlines of the first surface and the second surface of each of the prism structures are isosceles triangles.

5. The optical film as claimed in claim 1, wherein outlines of the first surface and the second surface of each of the prism structures are isosceles trapezoids.

6. The optical film as claimed in claim 1, each of the prism structures further comprising a third surface and a fourth surface opposite the third surface, wherein the third surface is connected with the first surface and the second surface, and the fourth surface is also connected with the first surface and the second surface, and the third surface and the fourth surface are mutually symmetrical.

7. The optical film as claimed in claim 1, wherein each of the prism to structures is shaped as a square pyramid.

8. The optical film as claimed in claim 1, wherein the plurality of prism structures corresponds to one of the cylindrical structures.

9. The optical film as claimed in claim 1, wherein the first surface of each of the prism structures is a light incident surface, and the curved surface of each is of the cylindrical structures is a light exit surface.

10. The optical film as claimed in claim 1, wherein the curved surface of each of the cylindrical structures is an aspherical surface.

11. The optical film as claimed in claim 10, wherein the aspherical surface comprises an ellipsoidal surface.
